(19) United States
(12) Patent Application Publication
(10) Pub. No.: US 2015/0069685 A1
(43) Pub. Date: Mar. 12, 2015

(54) STRUCTURE OF MOTOR-MOUNT FOR ELECTRIC VEHICLE

(71) Applicant: Hyundai Motor Company, Seoul (KR)

(72) Inventor: Seung-Won KIM, Seoul (KR)

(73) Assignee: Hyundai Motor Company, Seoul (KR)

(21) Appl. No.: 14/469,249

(22) Filed: Aug. 26, 2014

(30) Foreign Application Priority Data
Sep. 6, 2013 (KR) 10-2013-106975

(51) Int. Cl. F16F 13/08; F16F 3/087; B60K 1/00

(52) U.S. Cl. CPC F16F 13/08; B60K 1/00; F16F 3/0873
USPC 267/140.13; 267/141

(57) ABSTRACT

A structure of a motor-mount for an electric vehicle that supports a lower part of a motor of an electric vehicle includes a core into which a bolt fastened to the motor is inserted in a center, a stopper that is coupled to surround an outer circumferential surface of the core, and is made of rubber, an insulator that is connected to a lower end of the stopper, is coupled to a lower part of the core, and has a concave lower surface, and a housing into which the core, the stopper and the insulator are forcibly inserted, where the housing has a cylindrical shape in which a bottom is opened, and an outer circumferential surface of the stopper comes in contact with an inner circumferential surface of the housing.

### CROSS-REFERENCE TO RELATED APPLICATIONS

The present application claims priority to Korean Patent Application No. 10-2013-106975, filed Sep. 6, 2013, the entire contents of which is incorporated herein for all purposes by this reference.

### BACKGROUND OF THE INVENTION

1. Field of the Invention

The present invention relates to a structure of a motor-mount for an electric vehicle, and more particularly, to a structure of a motor-mount for an electric vehicle that supports a lower part of a motor of an electric vehicle in which an outer circumferential surface of a stopper comes in contact with an inner circumferential surface of a housing, a circular pressing ring coupled to an outer circumferential surface of an upper end of the stopper is further provided, and the stopper is previously compressed in a horizontal direction by the pressing ring before being forcibly inserted into the housing.

2. Description of Related Art

Vehicles equipped with a gasoline engine and a diesel engine that use fossil fuel have many problems such as environment pollution caused by an exhaust gas, global warming caused by carbon dioxide, and a respiratory disease caused by ozone production. Further, since there is a limited amount of fossil fuel on earth, the fossil fuel is in the danger of being exhausted.

In order to solve the problems, there have been developed electric vehicles such as a pure electric vehicle (EV) that travels by driving a driving motor, a hybrid electric vehicle (HEV) that travels by an engine and a driving motor, and a fuel cell electric vehicle (FCEV) that travels by driving a driving motor by a power generated in a fuel cell.

In general, the engine of the vehicle constantly generates vibration and generates vibration in all directions by a combination of various factors depending on bumps in the road during traveling of the vehicle.

Particularly, in the vehicle using the gasoline engine, a piston is operated in an order of suction, compression, explosion and exhaust through four stroke cycles to cause rotational torque of a crank shaft, and in this process, considerable vibration is generated.

In order to isolate such vibration, an engine-mount supporting the engine of the vehicle has been developed, and particularly, various researches for securing an isolation rate for main exciting force generated in the gasoline engine have been conducted.

However, unlike the vehicle using the gasoline engine, since there is no piston reciprocating motion such as explosion in the electric vehicle using the driving motor, a motor-mount needs to be changed so as to isolate shock vibration, jerk vibration, traveling vibration and gear whine noise unlike the engine-mount of the vehicle using the gasoline engine.

Similarly to the vehicle using the gasoline engine, in a structure of a motor-mount for an electric vehicle according to the related art, a rubber-mount structure, a hydro-mount structure and a pneumatic-mount structure are used, and FIG. 1 illustrates a structure of a motor-mount for an electric vehicle using the rubber-mount according to the related art.

Although not illustrated in the drawing, the hydro-mount structure is a structure in which a fluid is accommodated below a lower part of an insulator, and is configured to allow the fluid to flow and attenuate high-frequency vibration and low-frequency vibration. However, in the hydro-mount structure, a high-frequency dynamic characteristic is less effective than that of the rubber-mount structure because of viscosity of the fluid and flow resistance.

The pneumatic-mount structure is a structure in which damping force is obtained by using elastic force of a material of the insulator and allowing air to flow as a working fluid. The pneumatic-mount structure includes a chamber provided with an air hole for allowing the air to enter by elastic deformation of the insulator. Since the pneumatic-mount structure is easily manufactured, the pneumatic-mount structure is mostly used in a compact vehicle.

As illustrated in FIG. 1, the rubber-mount structure is a structure in which a damping effect is obtained by using elastic force of a material of an insulator 4, and a structure in which a bolt 1 inserted in a center of a core 2 and a motor of an electric vehicle are coupled and the insulator 4 is elastically deformed and restored along with vibration of the motor to attenuate the vibration.

Particularly, in the rubber-mount structure according to the related art, when a gear shift level of the gasoline engine is D, a gap is formed between a stopper 3 coupled to an outer circumferential surface of the core 2 and an inner circumferential surface of a housing 5 so as not to exhibit a high vibration characteristic.

However, in the electric vehicle in which there is no piston reciprocating motion, such a gap may be disadvantageous to shock and jerk, and large impact may be given to the housing when the stopper moves back and forth to cause vibration in a sear-rail of the vehicle.

Unlike the general gasoline vehicle of a concentrated mass, since the electric vehicle has a structure in which a mass of a vehicle body is distributed over a large area to have moment of inertia of 5 to 7 times greater than that of the general gasoline vehicle, the electric vehicle may be further adversely affected by shock or jerk.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a structure of a motor-mount for an electric vehicle in which there is no gap between an outer circumferential surface of a stopper and an inner circumferential surface of a housing that come in contact with each other, the stopper is previously compressed in a horizontal direction by a pressing ring to have high stiffness in the horizontal direction before being forcibly inserted into the housing, and a fluid system is applicable to a lower part of the housing.

In an aspect of the present invention, a motor-mount for an electric vehicle that supports a lower part of a motor of an electric vehicle includes a core into which a bolt fastened to the motor is inserted in a center, a stopper that is coupled to surround an outer circumferential surface of the core, and is made of rubber, an insulator that is connected to a lower end of the stopper, is coupled to a lower part of the core, and has a concave lower surface, and a housing into which the core, the stopper and the insulator are forcibly inserted, and that has a cylindrical shape in which a bottom is opened. An outer circumferential surface of the stopper comes in contact with an inner circumferential surface of the housing.

The structure of a motor-mount for an electric vehicle may further include a circular pressing ring that is coupled to an outer circumferential surface of an upper end of the stopper. The stopper may be previously compressed in a horizontal direction by the pressing ring before being forcibly inserted into the housing.

An outer diameter of the stopper, which is compressed in the horizontal direction by the pressing ring before being forcibly inserted into the housing, may be relatively smaller that an inner diameter of the housing.

An inclined angle of an upper end surface of the stopper with respect to a horizontal axis of the stopper after being forcibly inserted into the housing may be relatively smaller than an inclined angle of the upper end surface of the stopper with respect to the horizontal axis of the stopper before being forcibly inserted into the housing.

The inclined angle of the upper end surface of the stopper with respect to the horizontal line of the stopper after the stopper is forcibly inserted into the housing may be between 1° and 5°.

The structure of a motor-mount for an electric vehicle may further include a case that is coupled to an outer circumferential surface of a lower part of the insulator, and is disposed at a lower end of the housing, a nozzle lower plate that is disposed adjacent to the lower end of the insulator to be coupled to an inner circumferential surface of the case, has a central opening to which a membrane that vibrates along with flow of a fluid is attached, and has a circular flow path formed between the opening and an outer circumferential surface of the nozzle lower plate so as to allow the fluid to flow, a circular nozzle upper plate that is disposed between the lower end of the insulator and the nozzle lower plate, and has a hole formed to open or close the flow path of the nozzle lower plate, an upper fluid chamber that is formed between the concave lower surface of the insulator and the nozzle upper plate, and accommodates the fluid therein, a lower fluid chamber that is formed between a diaphragm coupled to a lower end of the case and the nozzle lower plate, and accommodates the fluid therein, and an outer pipe that is coupled to surround an outer circumferential surface of the case.

According to an exemplary embodiment of the present invention, since the core, the stopper and the insulator are forcibly inserted into the housing and the outer circumferential surface of the stopper comes in contact with the inner circumferential surface of the housing, there is no gap between the stopper and the housing, impact is not given to the housing even though the stopper is moved in the horizontal direction.

Since the structure further includes the circular pressing ring coupled to the outer circumferential surface of the stopper and the stopper is previously pressed by the pressing ring to be compressed in the horizontal direction before being forcibly inserted into the housing, even though the stopper expands, the stopper is not separated from the housing. Further, shock generated by collision with the housing when the stopper is restored can be removed.

Since the inclined angle of the upper end surface of the stopper with respect to the horizontal axis of the stopper after being forcibly inserted into the housing is relatively smaller than the inclined angle of the upper end surface of the stopper with respect to the horizontal axis of the stopper before being forcibly inserted into the housing, the stopper is pressed by the pressing ring before being forcibly inserted into the housing so as to receive force in the vertical direction, and when the stopper is forcibly inserted into the housing, the stopper receives force in the horizontal direction. Accordingly, stiffness in the horizontal direction is remarkably more increased than stiffness in the vertical direction, so that shock vibration of the vehicle can be improved.

Since the stopper is forcibly inserted into the housing to cause force in a direction opposite to the vertical direction, even though the insulator has high hardness, it is possible to maintain low static and dynamic characteristics in the vertical direction in the structure of a motor-mount for an electric vehicle as a whole. As a result, it is possible to secure high vibration insulation performance while improving durability performance of components.

Since the nozzle lower plate, the nozzle upper plate, the upper fluid chamber and the lower fluid chamber are provided below the insulator to allow the accommodated fluids to flow, high-frequency vibration and low-frequency vibration can be attenuated, and it is possible to improve traveling performance of the electric vehicle.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of a structure of a motor-mount for an electric vehicle according to the related art.

FIG. 2 is a cross-sectional view of a structure of a motor-mount for an electric vehicle according to an exemplary embodiment of the present invention.

FIG. 3 is a cross-sectional view illustrating a state where the structure of the motor-mount for the electric vehicle is separated from a housing before being forcibly inserted into the housing according to an exemplary embodiment of the present invention.

FIG. 4 is a cross-sectional view illustrating an inclined angle of a pressing ring and a length of a stopper compressed before being forcibly inserted into the housing in the structure of the motor-mount for the electric vehicle according to an exemplary embodiment of the present invention.

FIG. 5 is a cross-sectional view for describing supporting force applied to the stopper before being completely inserted into the housing in the structure of the motor-mount for the electric vehicle according to an exemplary embodiment of the present invention.

FIG. 6 is a cross-sectional view for describing supporting force applied to the stopper after being completely inserted into the housing in the structure of the motor-mount for the electric vehicle according to an exemplary embodiment of the present invention.

FIG. 7 is a cross-sectional view illustrating a direction of supporting stiffness received by the stopper and an insulator after being completely inserted into the housing in the structure of the motor-mount for the electric vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described with reference to the accompanying drawings so that those skilled in the Field of the Invention to which the present invention pertains may carry out the exemplary embodiment.

In an aspect of the present invention, a structure of a motor-mount for an electric vehicle that supports a lower part of a motor of the electric vehicle includes a core 10 into which a bolt 12 fastened to the motor is inserted in a center, a stopper 20 that is coupled to surround an outer circumferential surface of the core 10 and is made of rubber, an insulator 30 that is connected to a lower end of the stopper 20, is coupled to a lower part of the core 10, and has a concave lower surface, and a housing 40 into which the core 10, the stopper 20 and the insulator 30 are forcibly inserted and that has a cylindrical shape in which a bottom is opened. An outer circumferential surface of the stopper 20 comes in contact with an inner circumferential surface of the housing 40.

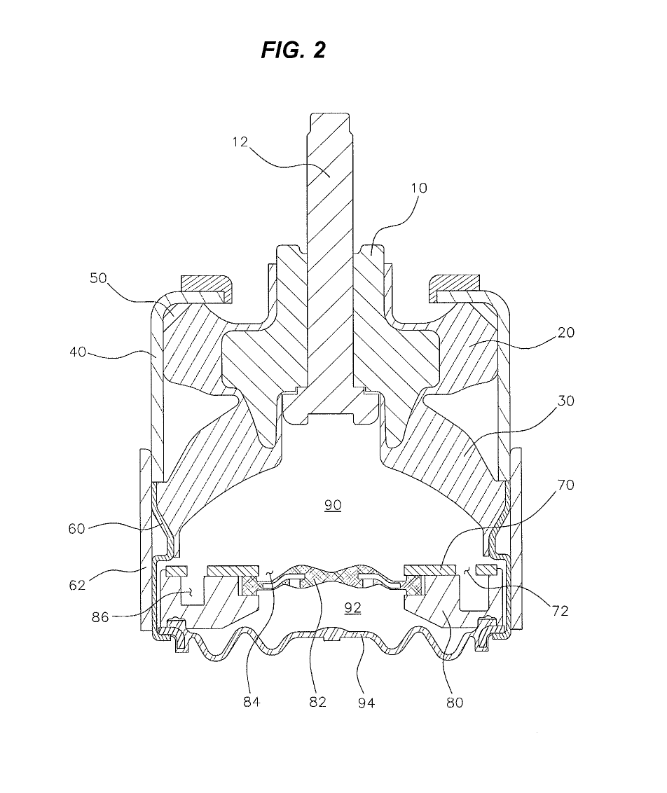

As illustrated in FIG. 2, the bolt 12 coupled to the lower part of the motor in order to mount the motor of the electric vehicle is vertically inserted into the center of the core 10, and upper parts of the bolt 12 and the core 10 protrude from a top of the housing 40.

When the structure of a motor-mount for an electric vehicle according to the present invention is viewed from the top as a whole, the bolt 12 and the core 10 preferably have a circular horizontal cross-section, but may have various shapes depending on a kind of the vehicle, a shape of the motor, and a fastened point of the motor and the bolt.

As illustrated in FIG. 2, the stopper 20 is coupled to the core 10 while surrounding the outer circumferential surface of the core 10. Since the stopper 20 is made of rubber such as natural rubber or synthetic rubber, the stopper can be elastically deformed by vibration of the motor.

That is, when the motor of the electric vehicle is moved in a horizontal direction by vibration causing the bolt 12 and the core 10 to be moved in the horizontal direction, the vibration of the motor is attenuated by the elastic deformation of the stopper 20.

As illustrated in FIG. 2, the insulator 30 is connected to a lower end of the stopper 20. Further, the insulator 30 is coupled to the lower part of the core 10, and the concave lower surface thereof forms a space for accommodating an upper fluid chamber 90 to be described below.

In the illustrated exemplary embodiment, the stopper 20 and the insulator 30 are connected to each other so as to have an “X”-shaped vertical cross-section as a whole. Similarly to the stopper 20, the insulator 30 is also made of rubber to isolate the vibration of the motor.

Similarly to the bolt 12 and the core 10, when the structure of a motor-mount for an electric vehicle according to the present invention is viewed from the top as a whole, the stopper 20 and the insulator 30 preferably have circular horizontal cross-sections, but may have various shapes depending on various factors.

As illustrated in FIG. 2, the core 10 is coupled to an upper center of the housing 40, and the housing has a cylindrical shape in which the bottom is opened. The inner circumferential surface of the housing 40 comes in contact with the outer circumferential surface of the stopper 20.

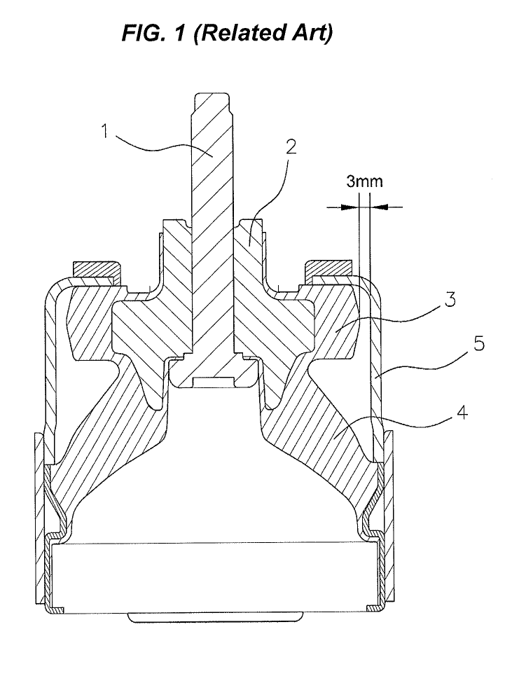

As illustrated in FIG. 1, in the structure of a motor-mount for an electric vehicle according to the related art, since a predetermined gap is formed between the stopper 3 and the housing 5, when torque is input to or output from the motor, the stopper 3 and the housing 5 collide with each other to cause shock vibration. However, in the structure of a motor-mount for an electric vehicle according to the present invention, since there is no gap between the stopper 20 and the housing 40, the shock vibration is decreased.

As illustrated in FIG. 2, the structure of a motor-mount for an electric vehicle according to the present invention further includes a circular pressing ring 50 coupled to an outer circumferential surface of an upper end of the stopper 20. The stopper 20 is preferably compressed in the horizontal direction in advance by the pressing ring 50 before being forcibly inserted into the housing 40.

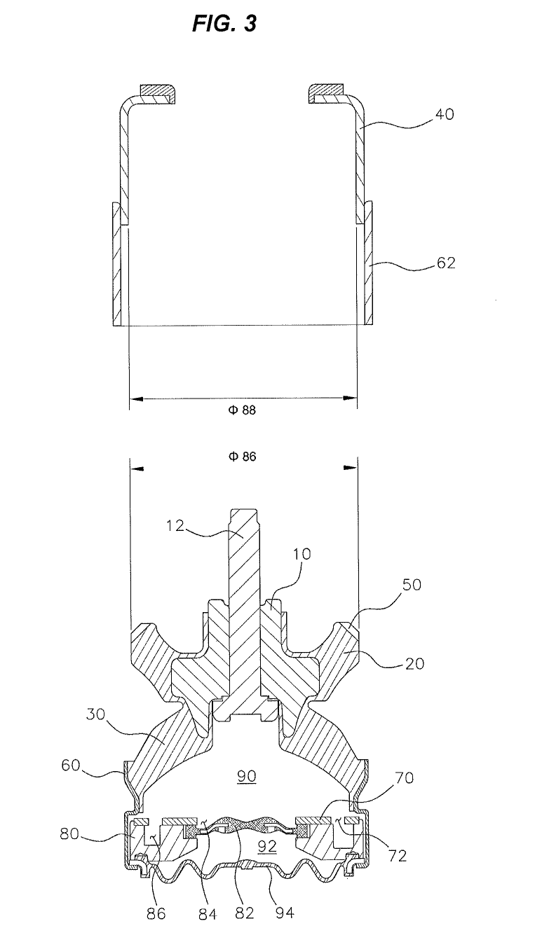

As illustrated in FIG. 3, the bolt 12, the core 10, the stopper 20 and the insulator 30 are coupled to each other to be forcibly inserted into the housing 40. At this time, the stopper is compressed toward its center in the horizontal direction by the pressing ring 50 as a whole before being forcibly inserted into the housing 40.

Since an outer diameter of the stopper 20, which is compressed by the pressing ring 50 before being forcibly inserted into the housing 40, is relatively smaller than an inner diameter of the housing 40, the stopper is inserted into the housing with ease. Specifically, it is preferred that the outer diameter of the stopper 20 before being forcibly inserted be 86 mm and the inner diameter of the housing 40 be 88 mm, but may have various dimensions.

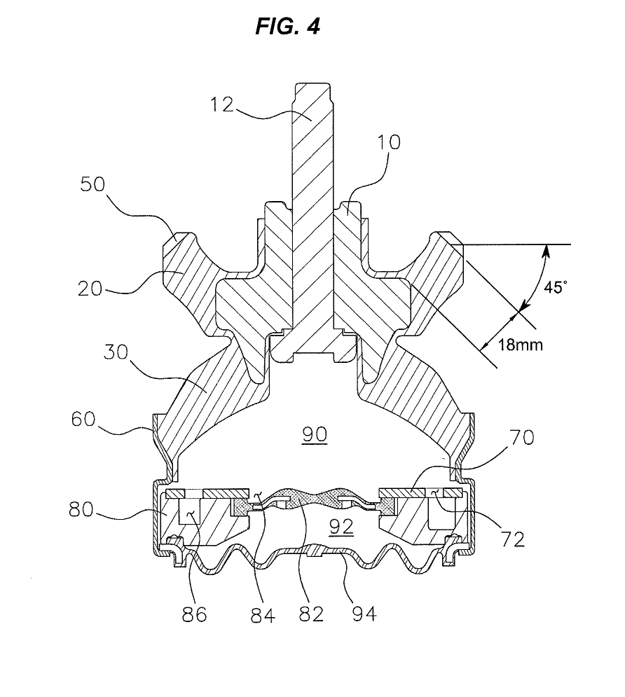

As illustrated in FIG. 4, the pressing ring 50 that compresses the stopper 20 before being forcibly inserted into the housing 40 has a predetermined inclined angle with respect to a horizontal axis of the stopper 20, and may have an inclined angle of about 45°.

A length of the stopper 20, which is a straight-line distance between the pressing ring 50 and an end of the stopper 20 at which the stopper before being forcibly inserted into the housing 40 is coupled to the core 10, may be 18 mm or other suitable dimension.

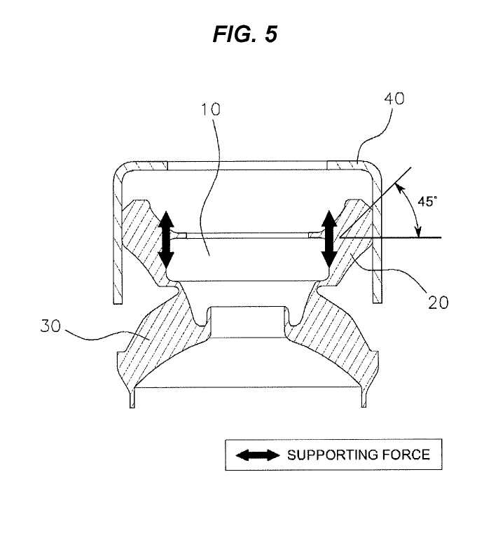

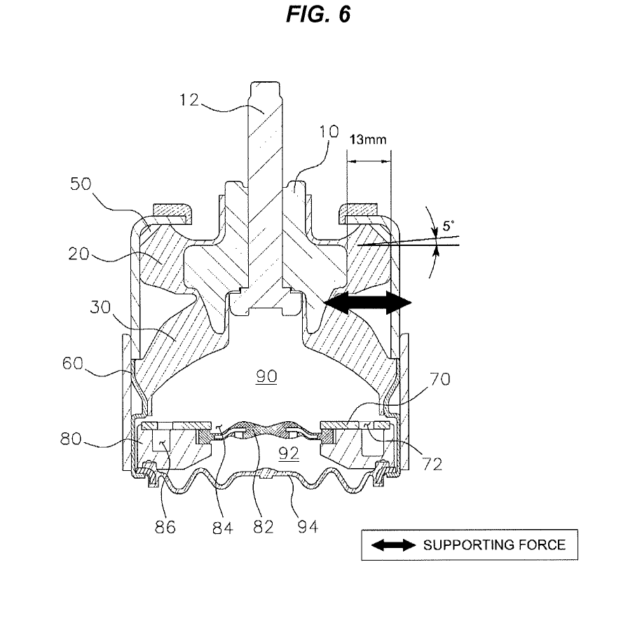

As illustrated in FIGS. 5 and 6, it is preferred that an inclined angle of an upper end surface of the stopper 20 with respect to the horizontal axis of the stopper 20 after the stopper 20 is forcibly inserted into the housing 40 be relatively smaller than an inclined angle of the upper end surface of the stopper 20 with respect to the horizontal axis of the stopper before being forcibly inserted into the housing 40.

Specifically, the inclined angle of the upper end surface of the stopper 20 with respect to the horizontal line of the stopper 20 before the stopper 20 is forcibly inserted into the housing 40 is preferably about 45°, and the inclined angle of the upper end surface of the stopper 20 with respect to the horizontal line of the stopper 20 after the stopper 20 is completely inserted into the housing 40 is preferably 1° or more and 5° or less.

The length of the stopper 20, which is the straight-line distance between the pressing ring 50 and the end of the stopper 20 at which the stopper after being forcibly inserted into the housing 40 is coupled to the core 10, is preferably 13 mm or other suitable dimension.

As illustrated in FIG. 5, the stopper 20 is pressed by the pressing ring 50 so as to receive supporting force in a vertical direction before the stopper 20 is forcibly inserted into the housing 40. However, as illustrated in FIG. 6, when the stopper 20 is forcibly inserted into the housing 40, the stopper 20 gradually receives the supporting force in the horizontal direction.

As stated above, since the stopper receives the supporting force in the horizontal direction, stiffness in the horizontal direction can be increased 3.5 times greater than stiffness in a vertical direction, and it is possible to prevent the stopper 20 from being separated from the housing 40.

When the stopper 20 and the insulator 30 having high hardness are generally used, durability performance of components is improved. However, since a static characteristic and a dynamic characteristic are increased, vibration isolation performance is degraded, so that the stopper 20 and the insulator 30 having low hardness need to be used. Accordingly, the durability performance of the components may be degraded.

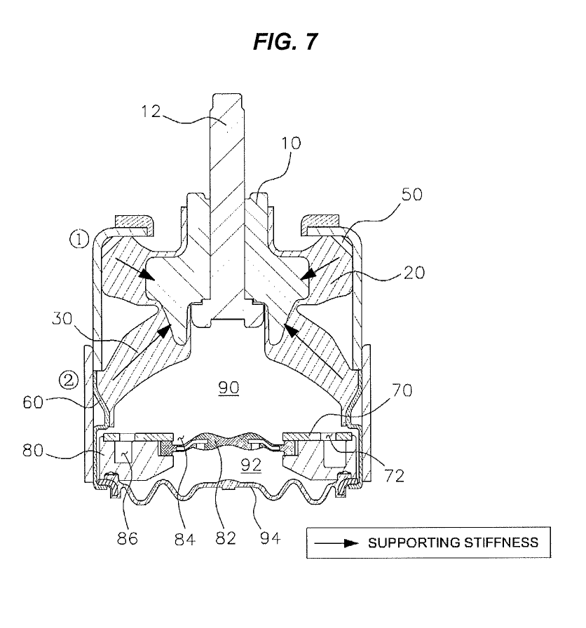

However, as illustrated in FIG. 7, in the structure of a motor-mount for an electric vehicle according to the present invention, since the stopper 20 is forcibly inserted into the housing 40 to generate force in a vertical lower direction, even though the stopper 20 having high hardness is used, it is possible to maintain low static and dynamic characteristics in the vertical direction.

For example, in the structure of a motor-mount for an electric vehicle according to the present invention, when the stopper 20 is compressed within the housing 40, the stopper 20 has a supporting stiffness of −10 kgf/mm in the vertical lower direction (in a direction of \textcircled{1} in FIG. 7), and the insulator 30 has a supporting stiffness of +30 kgf/mm in a vertical upper direction (in a direction of \textcircled{2} in FIG. 7). Accordingly, a total supporting stiffness is +20 kgf/mm in the vertical upper direction.

The structure of a motor-mount for an electric vehicle according to the present invention can improve insulation performance by 30% or more than that of the structure of a motor-mount for an electric vehicle of the related art in which the insulator 4 has a supporting stiffness of +20 kgf/mm in the vertical upper direction in order to have the total supporting stiffness of +20 kgf/mm in the vertical upper direction.

As illustrated in FIG. 2, the structure of a motor-mount for an electric vehicle according to the present invention preferably further includes a case 60 that is coupled to an outer circumferential surface of a lower part of the insulator 30 and is disposed at a lower end of the housing 40, a nozzle lower plate 80 that is disposed adjacent to a lower end of the insulator 30 to be coupled to an inner circumferential surface of the case 60, has a central opening 84 to which a membrane 82 that vibrates along with flow of a fluid can be attached, and has a circular flow path 86 formed between the opening 84 and an outer circumferential surface so as to allow the fluid to flow, a circular nozzle upper plate 70 that is disposed between the lower end of the insulator 30 and the nozzle lower plate 80 and has a hole 72 formed to open or close the flow path 86 of the nozzle lower plate 80, an upper fluid chamber 90 that is formed between the concave lower surface of the insulator 30 and the nozzle upper plate 70 and accommodates the fluid therein, a lower fluid chamber 92 that is formed between a diaphragm 94 coupled to the lower end of the case 60 and the nozzle lower plate 80 and accommodates the fluid therein, and an outer pipe 62 that is coupled to surround an outer circumferential surface of the case 60.

As illustrated in FIG. 2, the case 60 has a cylindrical pipe shape in which an upper surface and a lower surface coupled to the outer circumferential surface of the lower part of the insulator 30 are opened, and is disposed right below the lower end of the housing 40.

As illustrated in FIG. 2, the nozzle lower plate 80 has a substantially circular shape in which the opening 84 to which the membrane 82 can be attached is formed, and the circular flow path 86 is formed between the opening 84 and the outer circumferential surface of the nozzle lower plate 80 to allow the fluid to flow.

The fluid may flow through the flow path 86 formed in the nozzle lower plate 80 as described above, or may flow through a gap of the opening 84 to which the membrane 82 is attached. Vibration transferred to the structure of a motor-mount for an electric vehicle is attenuated by the flow of the fluid.

As illustrated in FIG. 2, the circular nozzle upper plate 70 having the hole 72 for opening or closing the flow path 86 of the nozzle lower plate 80 is disposed between the lower end of the insulator 30 and the nozzle lower plate 80, and the amount of the fluid flowing through the flow path 86 of the nozzle lower plate 80 is adjusted through the hole 72.

The upper fluid chamber 90 that accommodates the fluid therein is formed between the nozzle upper plate 70 and the lower surface of the insulator 30, and the lower fluid chamber 92 that accommodates the fluid is formed between the diaphragm 94 coupled to the lower end of the case 60 and the lower surface of the nozzle lower plate 80.

When the vibration is transferred through the motor of the vehicle in operation, the fluid accommodated in the upper fluid chamber 90 flows through the flow path 86 formed in the nozzle lower plate 80 or flows to the lower fluid chamber 92 through the gap of the opening 84 to which the membrane 82 is attached, so that the vibration of the motor is attenuated.

Accordingly, the structure of a motor-mount for an electric vehicle according to the present invention is a structure in which both a rubber-mount structure including the stopper 20 and the insulator 30 and a hydro-mount structure including the upper fluid chamber 90 and the lower fluid chamber 92 are used to remarkably improve traveling performance of the vehicle.

The present invention described above is not to be restricted by the aforementioned exemplary embodiments and the accompanying drawings. It is to be appreciated that those skilled in the art can variously substitute, change or modify the embodiments without departing from the technical spirit of the present invention.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A structure of a motor-mount for an electric vehicle that supports a lower part of a motor of an electric vehicle, the structure comprising:
a core into which a bolt fastened to the motor is inserted in a center;
a stopper that is coupled to surround an outer circumferential surface of the core, and is made of rubber;
an insulator that is connected to a lower end of the stopper, is coupled to a lower part of the core, and has a concave lower surface; and
a housing into which the core, the stopper and the insulator are forcibly inserted, the housing having a cylindrical shape in which a bottom is opened,
wherein an outer circumferential surface of the stopper comes in contact with an inner circumferential surface of the housing.

2. The structure of claim 1, further comprising:
a circular pressing ring that is coupled to an outer circumferential surface of an upper end of the stopper,
wherein the stopper is previously compressed in a horizontal direction by the pressing ring before being forcibly inserted into the housing.

3. The structure of claim 2, wherein an outer diameter of the stopper, which is compressed in the horizontal direction by the pressing ring before being forcibly inserted into the housing, is relatively smaller that an inner diameter of the housing.

4. The structure of claim 1, wherein an inclined angle of an upper end surface of the stopper with respect to a horizontal axis of the stopper after being forcibly inserted into the housing is relatively smaller than an inclined angle of the upper end surface of the stopper with respect to the horizontal axis of the stopper before being forcibly inserted into the housing.

5. The structure of claim 4, wherein the inclined angle of the upper end surface of the stopper with respect to the horizontal axis of the stopper after the stopper is forcibly inserted into the housing is between 1° and 5°.

6. The structure of claim 1, further comprising:
a case that is coupled to an outer circumferential surface of a lower part of the insulator, and is disposed at a lower end of the housing;
a nozzle lower plate that is disposed adjacent to the lower end of the insulator to be coupled to an inner circumferential surface of the case, wherein the nozzle lower plate has a central opening to which a membrane that vibrates along with flow of a fluid is attached, and has a circular flow path formed between the central opening and an outer circumferential surface of the nozzle lower plate to allow the fluid to flow;
a circular nozzle upper plate that is disposed between the lower end of the insulator and the nozzle lower plate, and has a hole formed to open or close the flow path of the nozzle lower plate;
an upper fluid chamber that is formed between the concave lower surface of the insulator and the nozzle upper plate, and accommodates the fluid therein;
a lower fluid chamber that is formed between a diaphragm coupled to a lower end of the case and the nozzle lower plate, and accommodates the fluid therein; and
an outer pipe that is coupled to surround an outer circumferential surface of the case.
